(19) United States
(12) Patent Application Publication
(10) Pub. No.: US 2011/0216794 A1
(43) Pub. Date: Sep. 8, 2011

(54) Pseudo-CW Quantum Cascade Laser System

(75) Inventors: Scott Howard, Ithaca, NY (US); Anthony Hoffman, Princeton, NJ (US)

(73) Assignee: GK TECHCOM LLC, Gladstone, NJ (US)

(21) Appl. No.: 13/032,143

(22) Filed: Feb. 22, 2011

Related U.S. Application Data
(60) Provisional application No. 61/309,490, filed on Mar. 2, 2010.

(51) Int. Cl. H01S 3/23; H01S 3/10

(52) U.S. Cl. 372/38.01; 372/38.02

(57) ABSTRACT

A laser system is proposed that is configured to provide a pseudo-CW signal at room temperature. The system utilizes an array of pulsed lasers that are controlled (in terms of turning “on” and “off”) to provide, in combination, a quasi-CW output signal. The activation of each individual laser is controlled to turn “on” and “off” in a predefined sequence, where at least one laser is “on” at any given point in time. Thus, by combining the outputs from the plurality of pulsed lasers onto a single output signal path, the resultant output signal from the system will be a pseudo-CW signal (the amount of “ripple” present in the signal controlled by factors such as the number of individual lasers in the plurality of lasers, the duty cycle of each individual laser, etc.). The duty cycle of the individual lasers can be controlled to provide a high power output signal (higher duty cycle), or provide a high wall-plug efficiency of the system (lower duty cycle).

### CROSS-REFERENCE TO RELATED APPLICATIONS

This application claims the benefit of U.S. Provisional Application No. 61/309,490 filed Mar. 2, 2010 and herein incorporated by reference.

### TECHNICAL FIELD

The present invention relates to a laser system and, more particularly, to a laser system capable of operating at room temperature (or over a wide temperature range) and utilizing an array of pulsed lasers that are controlled to provide (in combination) a pseudo-continuous wave (CW) output.

### BACKGROUND OF THE INVENTION

A QC laser is based on intersubband transitions between excited states of coupled quantum wells, using electron transport as the pumping mechanism. Unlike all other semiconductor lasers (e.g., diode lasers), the wavelength of the lasing emission of a QC laser is essentially determined by quantum confinement (i.e., by the thickness of the layers of the active region) rather than by the bandgap of the material forming the action region. As a result, a QC laser can be tailored to operate over a wide wavelength range using the same semiconductor material.

Indeed, QC lasers are typically designed to emit light in most of the mid-infrared (IR) portion of the electromagnetic spectrum and are likely candidates for many commercial and military applications that require a continuous wave (CW) mid-IR source with high output power and high device wall-plug efficiency. “Wall-plug efficiency” is a term of art and is defined as the total electrical-to-optical power efficiency of a given system (includes power supply losses, power required for cooling, etc.). A wall-plug efficiency for semiconductor diode lasers is generally on the order of 25%. However, QC lasers exhibit an efficiency on the order of only 1% (when operated in CW mode near room temperature). Efficiency is an important parameter in applications where the overall power budget is tight, and the low efficiency of QC lasers in this regime limit their usefulness in these applications.

Additionally, the performance of conventional QC lasers is fundamentally limited by their need to maintain operating temperatures within a rather stringent range, thus restricting their usefulness in many applications (particularly military applications that mandate a large temperature variation parameter).

US Patent Publication 2009/0052488 issued to A. Sugiyama et al. discloses a DFB quantum cascade laser element that is capable of CW operation at room temperature (or temperatures relatively close to room temperature). However the Sugiyama et al. structure is relatively difficult to fabricate, requiring the implementation of a top grating (as opposed to a conventional buried grating) and exhibiting certain limitations on the thickness of the associated layers and the wavelengths at which CW operation is possible. Further, it is not clear that the Sugiyama et al. structure would be able to operate at the elevated temperatures associated with military operations (or, alternatively, over wide temperature swings—another important requirement for many applications).

Thus, a need remains in the art for a more robust QC laser that is capable of CW operation for advanced applications including, but not limited to, military applications or any application requiring the operation of a CW laser at room temperature for extended periods of time, or operation over a wide temperature range.

### SUMMARY OF THE INVENTION

The need remaining in the prior art is addressed by the present invention which relates to a laser system and, more particularly, to a laser system capable of operating at room temperature (or over a wide temperature range) and utilizing an array of pulsed lasers that are controlled to provide (in combination) a pseudo-CW output. While in one embodiment the present invention utilizes an array of QC lasers, the principles of controlling the timing of plurality of pulsed lasers to create a pseudo-CW output is equally applicable to an array of pulsed diode lasers. Thus, the scope of the present invention is considered to cover any type of laser device.

In accordance with the present invention, a plurality of pulsed lasers (each individual laser operating at essentially the same wavelength) is configured such that the activation of each individual laser is controlled to turn “on” and “off” in a predefined sequence, where at least one laser is emitting a pulse at any given point in time. Thus, by combining the outputs from the plurality of pulsed lasers onto a single output signal path, the resultant output signal from the system will be a pseudo-CW signal (the amount of “ripple” present in the signal being a function of factors such as the number of individual lasers in the plurality of lasers, the duty cycle of each individual laser, etc.).

In practice, the plurality of pulsed lasers can be integrated onto a single substrate, formed on several substrates and packaged as a unitary structure, or even separately packaged as individual transmitters. Associated control electronics are used to turn the individual, pulsed lasers “on” and “off” in specified cycles, with only a subset of the lasers in the system being “on” at the same time. The individual lasers are turned “on” and “off” by supplying appropriate current or voltage pulses from the electronic control element.

The duty cycle of each individual laser can be tailored to provide the desired output for a specific application. For example, in applications where a higher output power is required, one or more of the individual lasers can be configured to have a higher duty cycle (e.g., 75, 80, even 99%), at the expense of wall-plug efficiency. Alternatively, each laser may be controlled to operate at its individual peak walk-plug efficiency (i.e., at a significantly lower duty cycle), thus creating a high overall wall-plug efficiency. Overlapping the turning “on” and “off” of the individual lasers is accordingly controlled to ensure that at least one laser is “on” at all times; it is also possible to coordinate their operation such that a first group of lasers turn “on” (and then “off”) at essentially the same time, with a second group then turning “on” at a later point in time.

In a further embodiment of the present invention, the control electronics can also be used to “tune” the operating wavelength of the plurality of lasers by, for example, changing the drive current or changing the ambient temperature of the lasers themselves (as controlled by a heatsink or other element). Alternatively, a separate external mechanism may be used to change the operating wavelength, such as by employing a mechanism to physically move an associated external diffraction grating. Any other appropriate means to provide optical wavelength tuning may be utilized with the laser system of the present invention.

The output pulses from the plurality of lasers are collected in an optical combiner (e.g., discrete arrangements of lenses and mirrors, optical fibers, integrated optical waveguides, a combination of discrete and integrated optics, or the like). The output from the optical combiner thus forms the desired pseudo-CW laser signal.

Other and further embodiments and aspects of the present invention will become apparent during the following discussion and by reference to the accompanying drawings.

### BRIEF DESCRIPTION OF THE DRAWINGS

Referring now to the drawings,

FIG. 1 illustrates an exemplary pseudo-CW laser system formed in accordance with the present invention;

FIG. 2 is a detailed diagram of an exemplary control electronics that may be used in conjunction with the system of FIG. 1;

FIG. 3 is an isometric view of an exemplary pseudo-CW laser system, illustrating in particular an exemplary collecting optics arrangement that may be used;

FIG. 4 is a timing diagram associated with using a pair of pulsed lasers operating at a 50% duty cycle to provide a pseudo-CW optical output signal in accordance with the present invention;

FIG. 5 is a timing diagram associated with using a set of three pulsed lasers operating at a 50% duty cycle, the outputs overlapping in the manner shown, to provide a pseudo-CW optical output signal in accordance with the present invention;

FIG. 6 is a timing diagram associated with using a set of four pulsed lasers operating at a 25% duty cycle to provide a pseudo-CW optical output signal in accordance with the present invention;

FIG. 7 is a timing diagram showing pairs of CW lasers being pulsed at essentially the same time to create the pseudo-CW optical output signal; and

FIG. 8 is a timing diagram showing a set of pulsed lasers controlled to exhibit separate, individual duty cycles.

### DETAILED DESCRIPTION

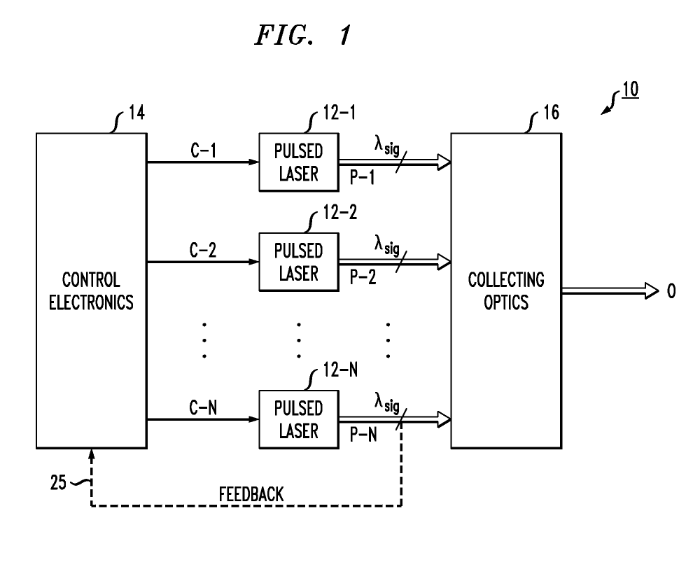

FIG. 1 is a simplified block diagram of an exemplary laser system 10 formed in accordance with the present invention. As shown, system 10 comprises a plurality of N lasers 12, where N 2. As mentioned above, each laser 12-i may be separately packaged, or groups of the lasers may each be mounted on a separate substrate, or the entire plurality of lasers may be formed as a monolithic structure on a single substrate. Importantly, each laser operates at essentially the same wavelength λ_{sig}, so that the output pulses from each separate laser may be combined to form the desired pseudo-CW output signal. As mentioned above, the operating wavelength of the plurality of lasers 12 may also be tunable, providing a pseudo-CW output signal at any desired wavelength over, for example, the mid-IR wavelength range.

Also shown in FIG. 1 is control electronics 14, which is used to control the operation of each of the separate lasers forming the plurality of N lasers 12. A separate control signal C is applied as to each device, with a control signal C-1 applied as the control input to laser 12-1, control signal C-2 applied as the control input to laser 12-2, and so on, with control signal C-N applied as the control input to laser 12-N. These electronic signals are used to operate the lasers in pulsed mode, with a predetermined duty cycle as appropriate for a given application. Indeed, as will be seen with reference to FIGS. 4-8, the duty cycle of each laser may be individually controlled by signals C-1 through C-N to allow for each individual laser to operate most efficiently and also allow for the plurality of laser output pulses to be best combined to produce the desired pseudo-CW output signal. Indeed, different applications may have different requirements (i.e., high output power vs. high wall-plug efficiency), and the plurality of control signals C may be used to turn “on” and “off” the individual lasers in the sequence best-suited for the particular application. Additionally, the duty cycle of each individual laser may be different, as necessary, for a specific situation.

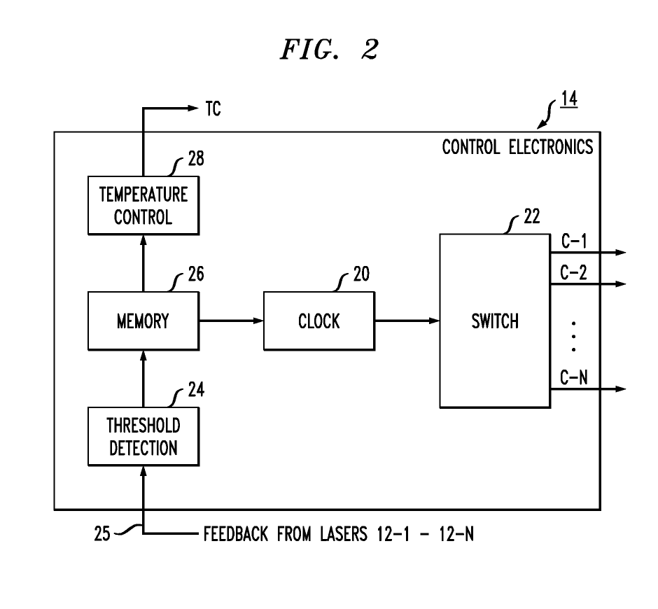

FIG. 2 is a detailed diagram of one exemplary embodiment of control electronics 14, showing the separate control signals C-1 through C-N, as well as a master clock 20 that functions to control the timing of the application of each signal C-1 through C-N, ensuring that at least one laser 12-i is “on” at any given time. In the particular embodiment as shown in FIG. 2, the clock output signal is applied as an input to a switch 22 that is used to create the particular control signals C-1 through C-N that will turn “on” and “off” the plurality of pulsed lasers 12 (not shown in FIG. 2) in a predefined sequence. It is to be noted that the lasers need not be turned “on” and “off” in any particular sequence (and, in arrangements of three or more lasers, two of the lasers may be turned “on” and “off” at essentially the same time). Indeed, if one or more lasers “fails” at any point in time (a “failure” being defined as either as generating no output signal, or generating an output signal at a power level too low for the particular application), it can be designated as permanently “off” and its control signal held at its “off” state. The on/off sequencing of the remaining lasers may thereafter be adjusted to accommodate for the loss of this individual laser. A power threshold detection unit 24 included within control electronics 14 may be used in this role, where threshold detection unit 24 is responsive to a feedback signal from pulsed lasers 12. If a specific laser 12-i is determined to “fail”, the identity of that specific device may be sent to a memory unit 26, which will then control switch 22 to no longer transmit a control signal C-i to that failed laser 12-i.

In accordance with the present invention, the control signals are also ‘timed’ to control the duty cycle of each pulsed laser and the amount of overlap (in time) between pulses, if any. These aspects are particularly illustrated in the timing diagrams of FIGS. 4-8, described below. Control electronics 14 may also include components necessary to provide wavelength tunability to the plurality of lasers 12. For example, a temperature control (TC) unit 28 is shown in FIG. 2 as part of control electronics 14, where unit 28 transmits a TC signal to, for example, a heatsink element (not shown) disposed in conjunction with the plurality of pulsed lasers. By changing the ambient temperature of pulsed lasers 12, the operating wavelength of the lasers will also change. Alternatively, a wavelength tunability signal may be used to adjust the spacing between an external grating and the active region of the plurality of lasers 12.

Referring again to FIG. 1, pulsed output signals P-1 through P-N from lasers 12-1 through 12-N, respectively, are thereafter applied as separate inputs to a collecting optics component 16, which functions to combine pulse streams P-1 through P-N and create the pseudo-CW output signal O. Collecting optics 16 may comprise free-space optical components (i.e., mirrors and lenses), optical fibers, integrated optical waveguides, or any combination of these various types of elements.

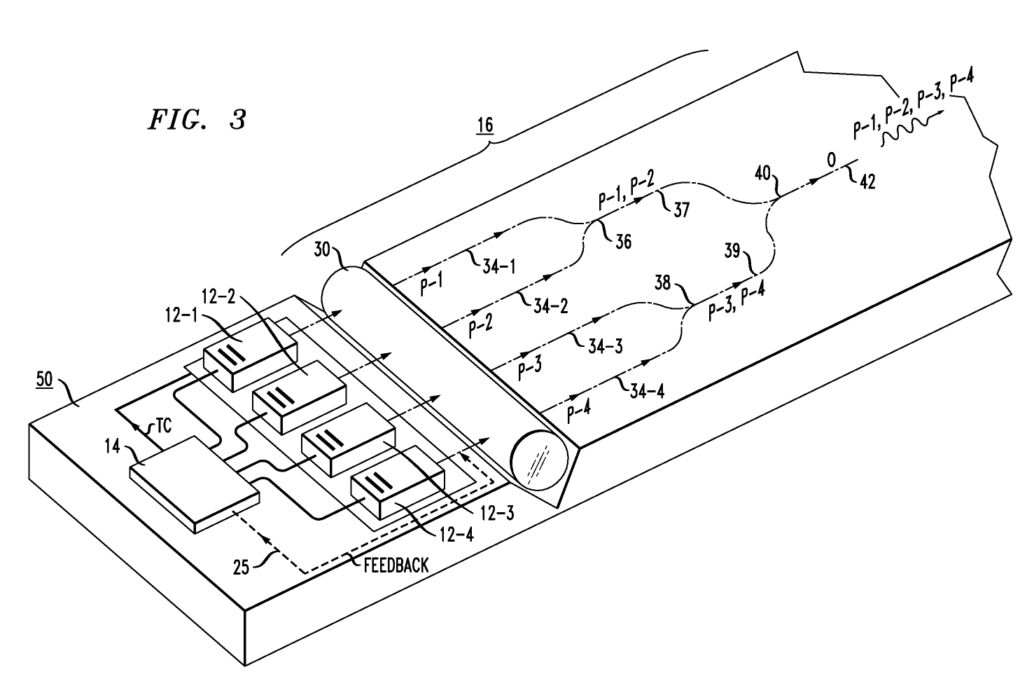

FIG. 3 is an isometric view of one embodiment of the present invention, particularly illustrating an exemplary collecting optics 16 that may be used to create pseudo-CW optical signal O from the plurality of pulsed laser output signals. In this particular example, a set of four pulsed CW lasers 12-1, 12-2, 12-3 and 12-4 is shown, where the lasers are supported on a substrate 50, with control electronics 14 supported on the same substrate 50. In this case, collecting optics 16 includes a cylindrical lens 30 and an integrated optical waveguide system 32. As shown, the pulsed output signals P-1, P-2, P-3 and P-4 will all pass through cylindrical lens 30, which will focus (separately) each signal and couple the signal into an associated waveguide 34-1, 34-2, 34-3 and 34-4 formed within substrate 50. The pulsed signals will continue to propagate along the waveguides and thereafter be combined into a single output signal. In the specific embodiment shown in FIG. 3, waveguides 34-1 and 34-2 are combined in a first optical coupler 36 so that signals P-1 and P-2 will be combined onto a first waveguide 37; waveguides 34-3 and 34-4 are similarly combined in a second optical coupler 38 to thereafter propagate signals P-3 and P-4 along a second waveguide 39. These pairs of signals are thereafter applied as inputs to a third optical coupler 40, which then functions to couple all four separate signals (P-1, P-2, P-3 and P-4) onto single output waveguide 42 as optical output signal O.

As mentioned above, each of the pulsed outputs P from lasers 12-1 through 12-N may be monitored, with a fraction of its output power applied as a feedback signal to control electronics 14 (an exemplary dotted line feedback path is shown between pulsed output signal P-N of laser 12-N and control electronics 14 in FIG. 1). By monitoring the performance of the individual lasers, should any individual laser begin to fail (e.g., its output power fall below a predetermined value), control electronics 14 can disable the associated control signal C and adjust the timing of the remaining devices to ensure the continuity of the pseudo CW output.

FIG. 4 illustrates an exemplary timing diagram for a system of the present invention that employs a pair of lasers 12-1 and 12-2. In this arrangement, each separate laser is pulsed to be “on” for the first half of a given transmission cycle, and then “off” for remaining half of the cycle (i.e., a 50% duty cycle). The timing of the turning “on” and “off” of each separate laser is controlled so that as laser 12-1 is turning “off” (see, for example, time T-1), laser 12-2 is turning “on”. By controlling lasers 12-1 and 12-2 in this manner, there is always an “output” pulse P-1 or P-2, and the signals can be combined in collecting optics 16 to create the pseudo-CW optical output signal O as shown in FIG. 4.

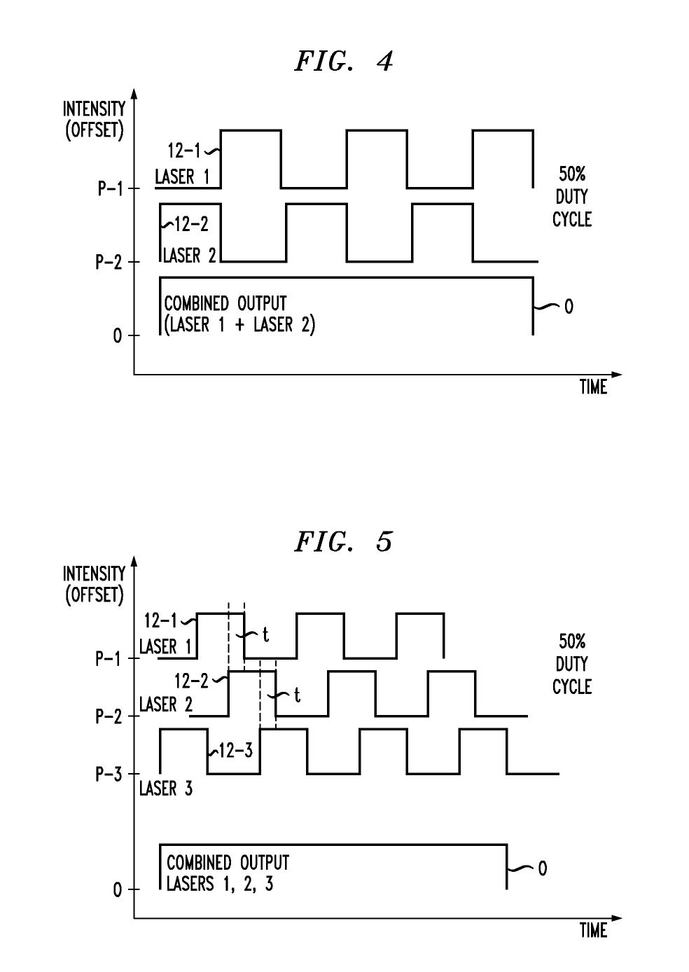

It is also possible to allow the “on” state of each separate laser device to overlap in time; that is, provide a temporal overlap between the “on-times” of the lasers. FIG. 5 illustrates a timing diagram associated with such an arrangement, in this case utilizing a set of three separate lasers 12-1, 12-2 and 12-3. In this case, the pulsing output of each laser (shown as P-1, P-2 and P-3) retains a 50% duty cycle, but the timing sequence is controlled such that there is a temporal overlap between the pulsed outputs (shown as “t” in FIG. 5).

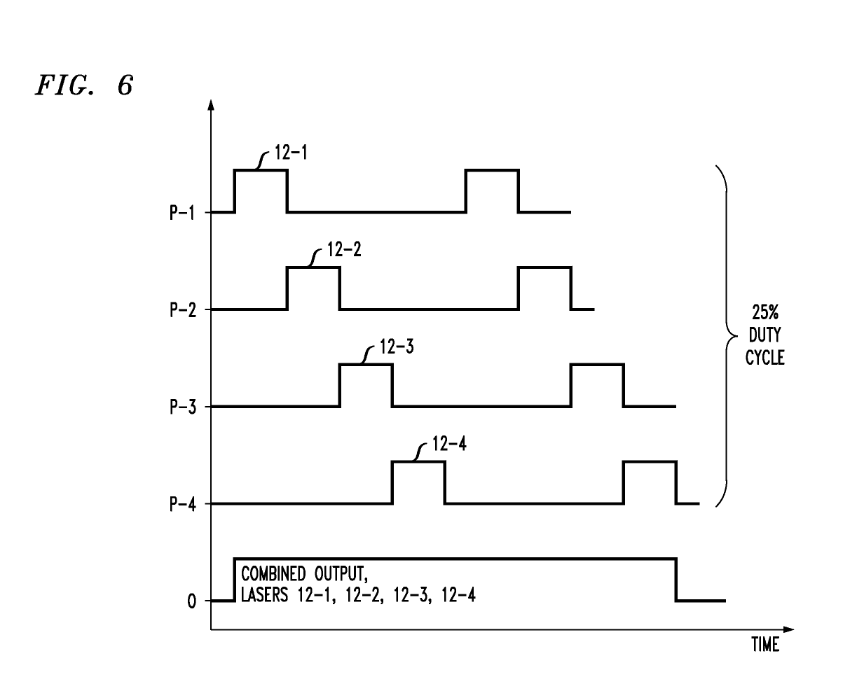

One advantage of the laser system of the present invention is that the longevity of the individual laser components may be extended by operating the devices at a lower duty cycle. FIG. 6 shows an arrangement where the individual lasers are operated at a 25% duty cycle, in this case with a set of four devices 12-1, 12-2, 12-3 and 12-4 turned “on” in sequence to provide the pseudo-CW output. Indeed, any suitable duty cycle can be utilized for the individual lasers as long as in combination they provide the desired pseudo-CW output.

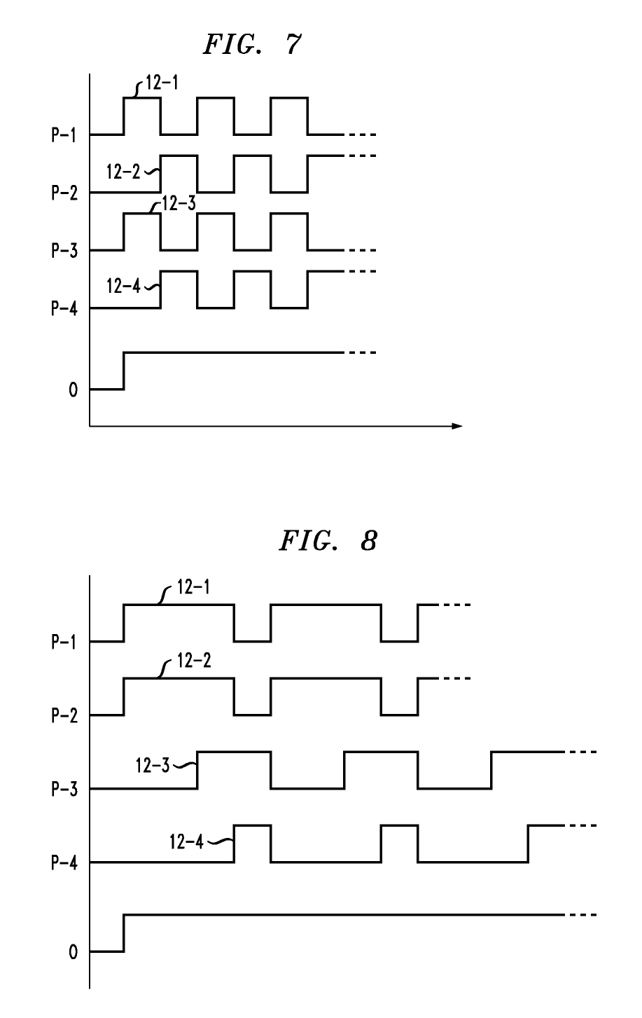

In another configuration of the present invention, the power in the pseudo-CW output signal can be increased by turning “on” more than one laser at a time. FIG. 7 is a timing diagram associated with four lasers (similar to the configuration associated with the timing diagram of FIG. 6), where in this case the control signals are designed to turn devices 12-1 and 12-3 “on” and “off” at essentially the same times, and similarly, to turn devices 12-2 and 12-4 “on” and “off” at essentially the same times. By having pairs of lasers on at any given time, the power delivered in the optical signal is significantly increased (when compared to configurations where only a single laser may be “on” at any point in time).

As mentioned above, it is possible to pulse the individual lasers to operate at any desired duty cycle and, in fact, it is further possible to operate the various lasers in a single array at different duty cycles. FIG. 8 is a timing diagram associated with this embodiment, where lasers 12-1 and 12-2 are shown as operating at a 75% duty cycle, with laser 12-3 operating at 50% duty cycle and 12-4 at a 25% duty cycle. The ability to individually tailor the duty cycle of each device allows for the user to create the desired level of output power, while controlling the specific operation of each device (an important factor in the determination of the wall-plug efficiency of the system).

The foregoing description of the preferred embodiment of the present invention has been presented for purposes of illustration and description. It is not intended to be exhaustive or to limit the invention to the precise form disclosed, and modifications and variations are possible in light of the above teachings, or may be acquired from practice of the invention. The embodiment was chosen and described in order to explain the principles of the invention and its practical application to enable one skilled in the art to utilize the invention in various embodiments as are suited to the particular use contemplated. Indeed, as mentioned above, the configuration of an array of pulsed lasers to produce a pseudo-CW output signal may utilize any type of suitable laser device—a diode laser, a quantum cascode laser, or the like. It is intended that the scope of the invention be defined by the claims appended hereto and their equivalents.

What is claimed is:

1. A laser system for generating a pseudo-CW optical output signal, the system comprising
a plurality of pulsed lasers, each pulsed laser operating at essentially the same wavelength λ_{signal} and generating a separate, pulsed optical output signal;
control electronics coupled to the plurality of pulsed lasers for controlling the turning “on” and “off” of each individual laser forming the plurality of pulsed lasers such that at least one laser is “on” at any point in time; and
collecting optics for receiving the plurality of pulsed optical output signals generated by the plurality of pulsed lasers and combining the plurality of pulsed optical output signals onto a single output signal path, forming a pseudo-CW optical output signal.

2. A laser system as defined in claim 1 wherein the plurality of pulsed lasers are disposed on a single support substrate.

3. A laser system as defined in claim 1 wherein the plurality of pulsed lasers are disposed on separate support substrates.

4. A laser system as defined in claim 1 wherein the plurality of pulsed lasers are tunable to change the value of the operating wavelength.

5. A laser system as defined in claim 4 wherein the plurality of pulsed lasers are tunable by changing the bias current applied to each separate laser.

6. A laser system as defined in claim 4 wherein the plurality of pulsed lasers are tunable by changing the temperature of each pulsed laser.

7. A laser system as defined in claim 1 wherein the system further comprises a feedback path between the outputs of the plurality of pulsed lasers and the control electronics, the feedback path for monitoring the power level of each pulsed laser.

8. A laser system as defined in claim 7 wherein the control electronics is configured to disable a laser if its power level drops below a predetermined threshold.

9. A laser system as defined in claim 1 wherein the optical combiner comprises:
a plurality of optical waveguides, each waveguide coupled to an output of a separate pulsed laser to support the propagation of its associated pulsed output signal; and
a plurality of optical couplers for joining separate sets of the plurality waveguides and combining sets of pulsed output signals onto a common signal path; and
an output optical waveguide coupled to the plurality of optical couplers such that the plurality of pulsed optical output signals all propagate along the output optical waveguide as the pseudo-CW optical output signal.

10. A laser as defined in claim 9 wherein the optical combiner further comprises an optical lensing arrangement disposed between the output of the plurality of pulsed lasers and the inputs of the plurality of optical waveguides.

11. A laser system as defined in claim 1 wherein the control electronics is configured to operate each separate pulsed laser at essentially the same duty cycle.

12. A laser system as defined in claim 1 wherein the control electronics is configured to operate each separate pulsed laser at an individually determined duty cycle.

13. A laser system as defined in claim 1 wherein the control electronics is configured to adjust the duty cycle of each pulsed laser to create a relatively high power optical signal, the duty cycles adjusted such that a majority of the pulsed lasers are “on” more than “off”, exhibiting a duty cycle greater than 50%.

14. A laser system as defined in claim 1 wherein the control electronics is configured to adjust the duty cycle of each pulsed laser to create a system with a relatively high wall-plug efficiency, the duty cycles adjusted such that a majority of the pulsed lasers are “off” more than “on”, exhibiting a duty cycle less than 50%.

15. A laser system as defined in claim 1 wherein the output pulses from the individual pulsed are controlled to partially overlap in time.

16. A laser system as defined in claim 1 wherein the plurality of pulsed lasers comprises a plurality of QC lasers.
